(19) United States
(12) Patent Application Publication
(10) Pub. No.: US 2007/0237325 A1
(43) Pub. Date: Oct. 11, 2007

(54) Method and apparatus to improve security of cryptographic systems

(76) Inventors: Michael Neal Gershowitz, San Jose, CA (US); Kenneth Patrick Dwyer, Roscommon (IE)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/699,989

(22) Filed: Jan. 31, 2007

Related U.S. Application Data
(60) Provisional application No. 60/763,903, filed on Feb. 1, 2006.

(51) Int. Cl. H04L 9/30

(52) U.S. Cl. 380/30

(57) ABSTRACT

A device having cryptographic capabilities is provided as including a security system connected to a microcontroller block, whereby the security system includes a non-volatile memory and a finite state machine. The finite state machine manages the device to maintain the content of an encryption key stored within the non-volatile memory secure, and to prevent access to the encryption key by a computer processing unit within the microcontroller block and/or an end user of the device.

This application claims the benefit of U.S. Provisional application 60/763,903, filed on Feb. 1, 2006, which is hereby incorporated by reference in its entirety.

### BACKGROUND OF THE INVENTION

1. Field of the Invention

A finite state machine (FSM), Non Volatile Data Store (NVDS), and cryptographic blocks are added to a general purpose computing system to provide a higher level of data security and tamper resistance.

2. Description of the Background Art

Present methods for preventing unauthorized access to information often involve the encryption of information by mathematical means using digital computer systems. To encrypt and de-crypt the information a numerical value known as a cryptographic key, or more simply known as just a key must be used. If unauthorized persons discover the key value, then the information protected by that key may be compromised.

Systems in use today are usually based on general-purpose computing devices, and handle the key values via CPU access. The CPU operation is governed by a sequence of instructions stored in memory. The nature of general purpose computers are such that there are many methods by which those skilled in the art can modify the instructions stored in computer system memory, and cause such a system to expose the value of the secret key to an unauthorized person.

### SUMMARY OF THE INVENTION

This invention seeks to eliminate the possibility of an unauthorized person modifying instructions stored in a computer system with the intent to expose the value of a secret key, by restricting access of the key value information to a separate finite state machine that operates autonomously from the CPU. Furthermore, overall system integrity and security are improved by using the finite state machine to also provide additional tests to the general purpose computer system and the program memory of the CPU, to ensure that no tampering or unauthorized modification has been made to the control program before the CPU is allowed to begin operation. Also, a means by which the CPU control program can be encrypted is provided, so that when memory devices external to an integrated one chip computing system are used in the system, analysis to reverse engineer the operation of the program are thwarted. Methods are provided to load into external memory the control program that is encrypted as noted above, or as encrypted by other means.

To achieve the above and other objects, a device is provided including a microcontroller block having a general purpose computer processing unit that controls operation of the device; and a security system coupled to the microcontroller block, the security system including a finite state machine that uses an encryption key to control encryption and decryption of confidential data used by the computer processing unit, and that maintains content of the encryption key and prevents access to the encryption key by the computer processing unit and an end user of the device.

The above noted objects and others may also be achieved whereby a device is provided including a microcontroller block having a general purpose computer processing unit that controls operation of the device; and a security system coupled to the microcontroller block, the security system including a cryptographic engine that uses an encryption key to encrypt and decrypt confidential data used by the computer processing unit, a random number generator that generates the encryption key, a non-volatile memory that stores the encryption key and configuration bits that set operational parameters of the device, and a finite state machine that controls access of the non-volatile memory so that the encryption key is used and maintained without access by the computer processing unit and an end user of the device.

### BRIEF DESCRIPTION OF THE DRAWINGS

FIG. 1 is a state diagram that shows major states during the life cycle of a product used in connection with the security system of the present application.

FIG. 2 is a block diagram showing the basic structure of a security system of the present application, and how it is interfaced to and integrated with common MCU architectures.

FIG. 3 is a flow diagram depicting the major processes performed for the operation of the security system, some of which being performed by the finite state machine, others by the CPU and others by manual intervention during the configuration process.

FIG. 4 is a simplified flowchart of finite state machine basic operation.

FIG. 5 is a simplified flowchart of finite state machine cryptographic key generation.

FIG. 6 is a simplified flowchart of finite state machine encrypted program load operation.

### DETAILED DESCRIPTION

In general, a random number generator circuit (RNG), in conjunction with a general purpose digital computer (CPU) and/or hardware crypto acceleration (in the cryptoblock) using well established techniques, is capable of generating numerical values known as “cryptographic keys”, which can be used to protect information from access by unauthorized persons. The methods of cryptography are well known to those skilled in the art. The embodiments as will be described are applicable to all encryption types and methods using single or multiple keys, such as symmetric and asymmetric methods. As long as the keys are kept secret, the information they protect remains protected. If the keys become known, then unauthorized persons can access the information. The system and method as will be described protects the secrecy of the cryptographic keys.

Common implementations of modern digital computer systems can integrate all of the main functions of a system onto a single integrated circuit. These functions include a CPU, RAM and program memories, peripheral devices and other functions necessary so that a single device solution or a low total component count solution is achieved. These devices are commonly referred to as a Microcontroller or MCU.

In an embodiment hereinafter described, all the functions are contained within the same physical package, integrated onto the same silicon substrate as the MCU. At least a portion of the memory in this system has a characteristic that permits it to continue to store information after operating power to the CPU and other peripheral devices of the system have been removed. Such memory systems are well known to those skilled in the art, and will be hereinafter referred to as Non Volatile Data Store (NVDS).

It is also possible that some of the memory and peripherals of this computer system may be external to the MCU device itself, and this description is applicable to those systems, as well as systems that are made up of entirely non-integrated elements that thus have no physical MCU partition at all.

In an embodiment to be described, a finite state machine (FSM) is added to a traditional digital computer system. The finite state machine (FSM) as hereinafter referred to should be understood as a compact, optimized digital solution targeted to perform dedicated tasks of narrowed scope. The FSM is implemented to include or perform only the functionality required for the intended purpose or tasks. In the FSM, the architecture is embedded in the registers of the state machine and the controlling state transition tables (combinatorial or microcode). As such, the FSM is very difficult to reverse engineer, and is thus considered as secure. In contrast, a computer processing unit (CPU), a complex instruction set computer (CISC) or a reduced instruction set computer (RISC) are generally understood to be intended to perform multiple tasks, and thus have functionality and flexibility which are not optimal for performing dedicated tasks of narrow scope. The CPUs, RISCs and CISCs have architecture that is regular, and thus are relatively easy to understand and reverse engineer. For example, the flexibility of such general CPUs, CISCs and RISCs can lead to weaknesses in architecture, wherein redundant paths to registers may compromise security.

The FSM is provided to manage certain security sensitive matters such as the generation and storage of keys, verification that the traditional computer system has not been tampered with or had unauthorized modifications made to it, and other matters necessary to ensure the security of the complete system. The NVDS, FSM, and all peripherals required to generate and store keys may be integrated into a single device or encapsulated into a single tamper resistant package.

In the description that follows, the term device (product) or system are used with the intended meaning being that the device is an element within the system. The device may contain the elements described previously in a single tamper resistant package. It may also be possible that more elements or fewer elements are included in the same package or encapsulation as the device defined previously. Although this does not affect operation, this could however affect the level of tamper resistance possible for a given implementation of the system.

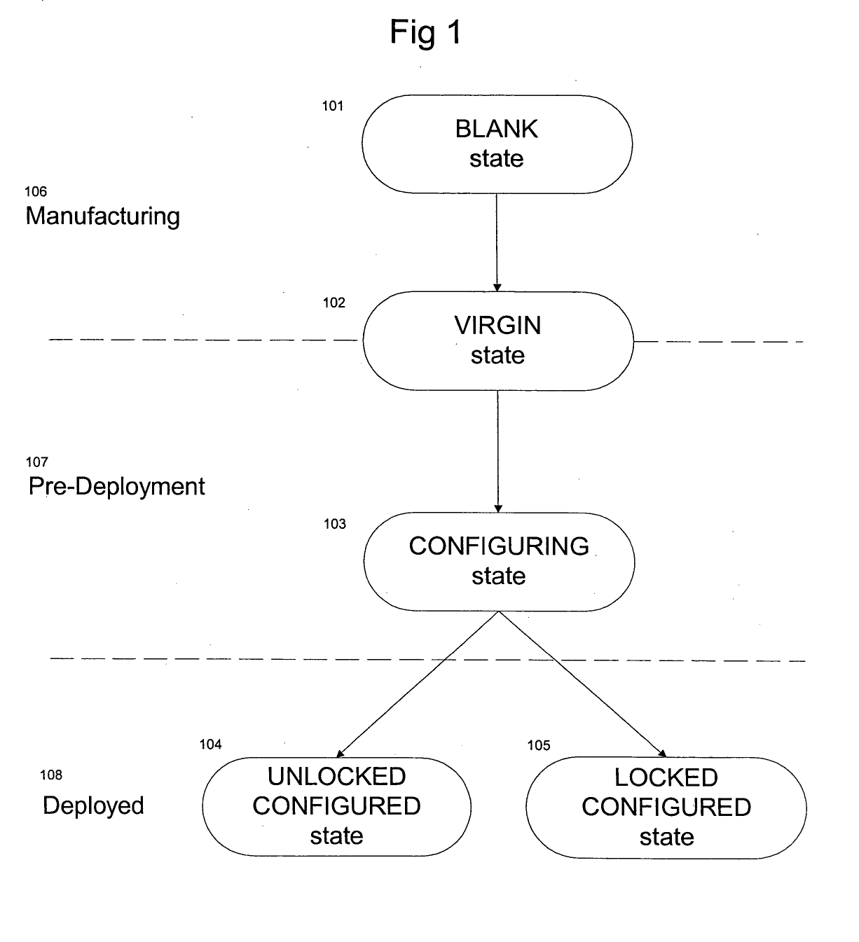

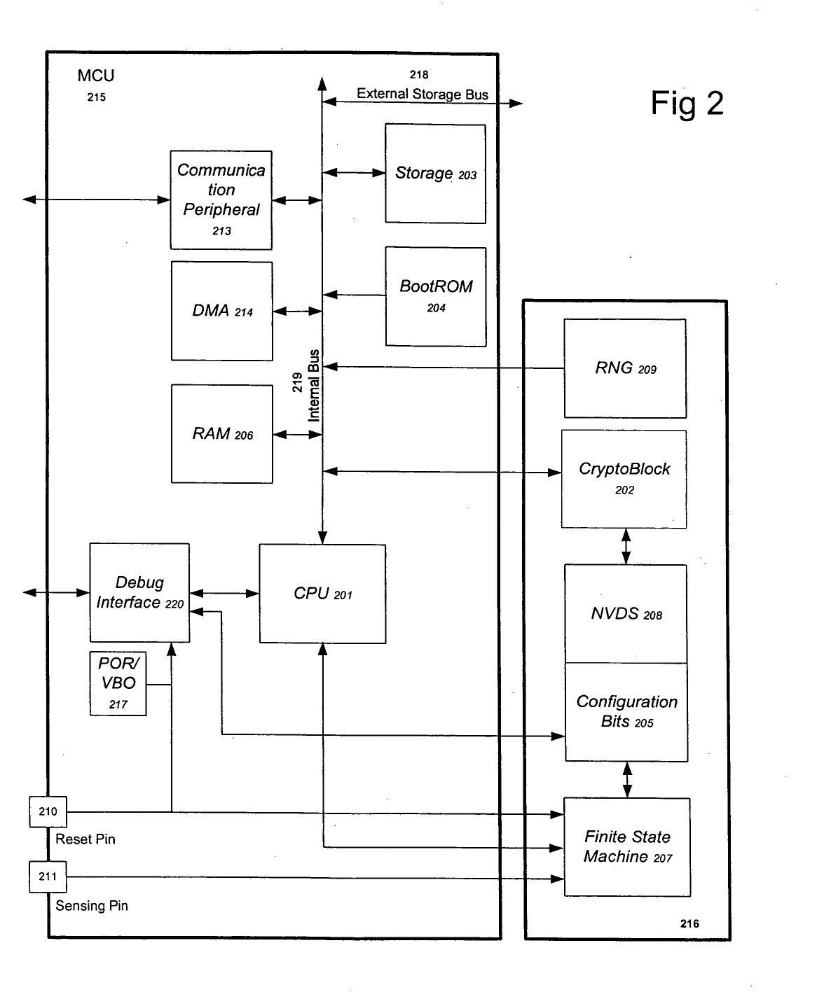

In greater detail, FIG. 2 illustrates a system in accordance with an embodiment of the application, and FIG. 1 identifies the major logical states that the device as shown in FIG. 2 may be in at any time during its life cycle. While there are additional states that the Finite State Machine (FSM) 207 requires for operation, a clear understanding of these major product life cycle states is important.

With reference to FIG. 1, the BLANK state 101 is the state of the device immediately following manufacture. In the BLANK state, depending upon the methods used to implement the non-volatile memory elements of the FSM 207 as shown in FIG. 2, it is possible that the memory elements are in a random or unknown state. Before any meaningful use of the device, it is necessary to initialize the values of certain non-volatile memory elements to specific values meaningful to the FSM 207. These certain memory elements will control the overall behavior of the FSM 207, and are hereafter referred to as configuration bits 205. A possible embodiment of the configuration bits 205 would be to use some area of the Non Volatile Data Store (NVDS) 208 in a bit addressable fashion to store the state of these bits. A method of altering the state of the configuration bits 205 would be to use a debug interface 220 shown in FIG. 2.

The VIRGIN state 102 is the state of the device where all memory elements required for correct initial FSM operation, and eventual protection of any secrets, have been set to a known initial value. It is entirely possible, depending upon the technology used to manufacture the NVDS 208 and set the configuration bits, that there may be no BLANK state for some embodiments of this system. This does not affect the operation of the system, but may affect the method of manufacturing the system. The CONFIGURING state 103 is a state where some of the memory elements have been changed from VIRGIN state values, but there remains additional tasks to be performed before all memory elements can be appropriately set for use.

The UNLOCKED CONFIGURED state 104 is a state where all necessary setting of the memory elements has been completed, but the security policy implemented is such that further modification of some aspects of the configuration is possible later in time, without the need to return the device to the VIRGIN state first. The LOCKED CONFIGURED state 105 is a state where all necessary settings of the memory elements have been completed, and no further change to the memory elements are permitted without first returning the device to the VIRGIN state. The locking mechanism is provided as a deterrent to tampering with the device once it has been deployed for end use by the user. Although it is beyond the scope of this application to define the security policy to be used for a given product, it is intended that all security policies would be usable within the capability of the system.

The states previously defined correspond to three stages in the product life cycle that are also indicated in FIG. 1. The BLANK and VIRGIN states are part of the manufacturing stage 106 of the device or product. In these states, there are no secrets contained in the device. Note that since there are provisions for the device to be returned to the VIRGIN state after manufacture, the VIRGIN state is also considered to be applicable to the Pre-Deployment stage 107 as well. The CONFIGURING state is part of the pre-deployment stage 107 of the product. This pre-deployment stage involves handling secrets that will influence the overall security of the product once it is deployed to end users. It is envisioned that the pre-deployment stage will be in a secure manufacturing environment and that the end user will never have access to the product in this stage. The UNLOCKED CONFIGURED and the LOCKED CONFIGURED states represent the deployed stage 108 of the product. In this stage the product is made available to end users, so that they may add additional secrets and information to the system, but not modify the basic security policy configured into the product during the pre-deployment stage.

FIG. 2 identifies the functional blocks of the system or device and their interconnection. These blocks include the traditional blocks of conventional MCU 215, and blocks necessary for the proper operation of security system 216. MCU 215 includes storage 203, boot ROM 204, communication peripheral or peripherals 213 (not limited to one communication peripheral or one type of communication peripheral), DMA (direct memory access) 214, RAM 206 and CPU 201, all connected to an internal bus 219 of the MCU 215. The internal bus may also be coupled to an optional external storage bus 218. A debug interface 220 is coupled directly to the CPU 201, communicates externally of MCU 215, and is also connected to security system 216. Reset and sensing pins 210 and 211 control external connection and communication with MCU 215. Reset pin 210 is coupled to debug interface 220, and through MCU 215 to FSM 207 of security system 216. A power on reset/voltage brown out detector (PORNBO) 217 is connected between reset pin 210 and debug interface 220. Also, sensing pin 211 is coupled through MCU 215 to FSM 207 of security system 216. The components of conventional MCU 215 operate generally in a manner as would be known and understood by one of ordinary skill, unless as otherwise noted hereinafter.

The MCU 215 may have on chip storage 203, such as RAM, flash, hard drive or NAND flash, and may also be capable of accessing external media via external storage bus 218. Upon application of power to the system, or following a reset signal to the system, the CPU 201 and debug interface 220 are inhibited from operation until they are enabled by the finite state machine (FSM) 207. Reset pin 210 or power on reset/voltage brown out detection circuit (PORNBO) 217 makes the reset or power cycle condition known to the controlling logic of the CPU 201, debug interface 220 and the FSM 207.

Security system 216 is illustrated in FIG. 2 as interfaced and/or integrated with MCU 215. Security system 216 includes RNG (random number generator) 209 and cryptoblock 202 (sometimes referred to hereinafter as cryptographic engine) that are coupled to internal bus 219 of MCU 215, when security system 216 is interfaced with MCU 215. NVDS (non-volatile data storage) 208 is shown as storing configuration bits 205, and is connected to cryptoblock 202. NVDS 208 is also coupled to debug interface 220 of MCU 215, when security system 216 is interfaced with MCU 215. FSM 207 is coupled to NVDS 208, and with CPU 201, reset pin 210 and sensing pin 211, when security system 216 is interfaced with MCU 215.

The FSM 207 begins operation, based on a coding sequence that has been established at the time of manufacture of the device. The method by which the FSM coding sequence is stored is important insofar as it should be impossible for critical sections of the coding sequence to be modified after manufacture without destruction of or damage to the device. Provisions can however be made where the FSM control program can be modified after manufacture, for addition of future capabilities and functions of the state machine. However, the first actions taken by the FSM 207 following a reset must be absolute and are described subsequently.

In the performance of the actions to be taken by the FSM 207 it will be necessary for the FSM 207 to be aware of different options required for correct operation. The product manufacturer specifies these options during the pre-deployment phase 107 of the product by setting configuration bits 205 that may be subsequently read by the FSM 207. During the pre-deployment phase, configuration bits can be set by an authorized user via the debug interface 220, or by the FSM 207 itself to indicate progress or status in the configuration process. One of the options that may be selected is the automatic generation of a secret key value. To produce the key the RNG 209, cryptoblock 202 and MCU 215 can be used in a manner as will be described subsequently and as should be well within understanding of those skilled in the art. The FSM 207 maintains control of the device function during key generation, even if the MCU 215 is used. Once a secret key value has been generated, it is stored in the NVDS 208. For additional security, the secret key value can be stored in other non-volatile memory elements on the device, to make reverse engineering and tampering more difficult. The function is similar regardless of where the secret key is stored.

When the FSM 207 makes use of the CPU 201 and/or the cryptoblock 202 to assist in secret key generation, the CPU 201 operation is controlled by the program contained in the bootROM 204. The bootROM content is defined during manufacture of the device, and cannot be modified outside of the manufacturing phase of the product life cycle. To maintain a high level of security, any memory elements used by the CPU 201 to compute a key value or any other secret will be restored to a known trivial value by the CPU program. These memory elements include RAM 206 and any registers internal to the CPU 201. As a further security measure, any accesses to the bootROM 204 code after deployment can be restricted, the restriction level being controlled by setting appropriate configuration bits 205 during the pre-deployment phase. When all of the necessary configuration bits 205 have been set, and the secret key generated and stored to support the desired security policy, the device may be optionally locked by setting an appropriate configuration bit or bits 205. Once locked, the debug interface 220 is disabled, so no further modification of the configuration bits 205 is possible unless done by the FSM 207 itself. An example of the FSM 207 modifying configuration bits after locking would be in response to a request to return the device into the VIRGIN state 102.

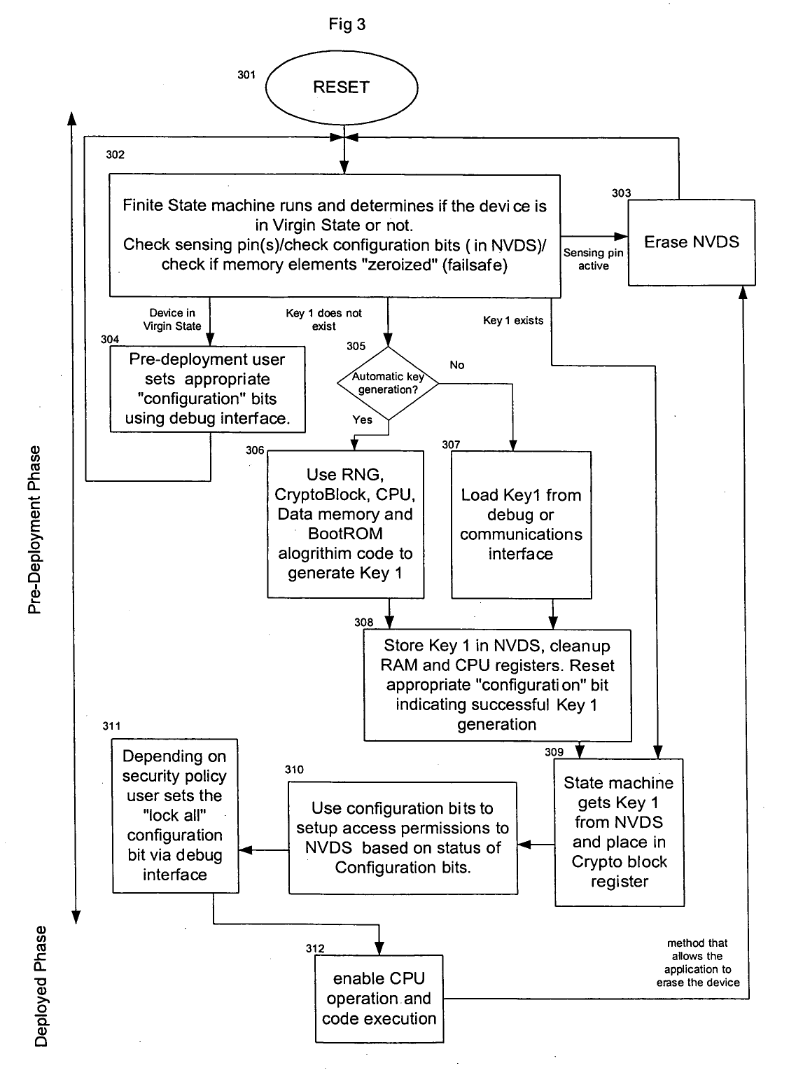

FIG. 3 is a flow chart that illustrates the high level function of security system 216 in the pre-deployment stage, when the security function is to be enabled.

FIG. 3 shows the interaction of the FSM 207 and the pre-deployment user who is establishing the security policy for the device by setting appropriate configuration bits 205. In the pre-deployment configuration process, the device will be placed through several reset cycles, so this flow diagram will be traversed several times in several different ways.

If a reset of the device is being performed by cycling power, it should be understood that the content of the NVDS 208 must not be affected by the power cycling. Depending upon the technology used to implement NVDS 208, it is possible that external power must necessarily be maintained to preserve the contents of NVDS 208. In such an implementation, the description of “power cycle” means to cycle the power to other sections of the device, but to leave power to the NVDS 208 in place at all times.

Reset of the device occurs when a signal is applied to the reset pin 210 shown in FIG. 2, or a supply voltage cycle triggers the POR/VBO 217. The effect of the reset on the FSM 207 is to place the machine into the RESET state in step 301. The first action following reset is to determine the state of the device. This action is performed by the FSM 207 in step 302. There are four possible outcomes of step 302: 1) the device is in the VIRGIN state; 2) the device is not in the VIRGIN state and no KEY1 exists; 3) the device is not in the VIRGIN state and KEY1 does exist; or 4) the device is in any state and the sensing pin 211 is active to thus indicate that the device is to be returned to the VIRGIN state.

If the device is in the VIRGIN state 102, the FSM 207 will proceed to step 304 to allow a pre-deployment user the opportunity to set configuration bits to control FSM operation on subsequent power cycles. If the device had been previously powered, and configuration bits had been set, it must be determined if a secret key exists or not, and if not, if a secret key is to be automatically generated or not. If a secret key does not exist (Key1 does not exist) and the device is not in the VIRGIN state, then step 305 determines if a key is to be automatically generated, by testing the state of the appropriate configuration bit 205, which would have been previously set in step 304. If a secret key has already been stored in the device (Key1 exists) and the device is not in the VIRGIN state, then the FSM 207 will proceed to state 309 and prepare for use of that key. State 303 is a means by which NVDS 208 is erased (including all keys and configuration bits) and the device is returned to the VIRGIN state, for re-use with a new security policy and different secret key. The CPU 201 can cause transition to step 303, or in the alternative step 303 may be entered when sensing pin 211 is active. FIG. 3 only shows sensing pin 211 activity following reset. However, the design of the device can and should be such that activation of the sensing pin 211 at any time will result in a transition to state 303 and a return of the device to a VIRGIN state 102. Techniques for such operation or use of the sensing pin are well known to those skilled in the art.

The pre-deployment user, upon determining that the device is in the VIRGIN state, will begin a sequence of operations in step 304 of FIG. 3, upon which the configuration bits 205 will be altered from the values they were previously set to in the VIRGIN state. A method of altering the state of the configuration bits would be to use the debug interface 220. There are many configuration bits, each with a different purpose to control various aspects of the FSM 207 operation. For the present discussion, it should be noted that one or more configuration bits will indicate if a cryptographic key is to be generated and stored automatically by the system. Once the initial configuration bits 205 have been set, the system is subsequently reset (either by power cycle or application of a reset signal or instruction) and the FSM 207 again begins operation. In step 302, the FSM 207 is able to determine that the device is no longer in the VIRGIN state, because some of the configuration bits 205 have been changed from VIRGIN state values. The FSM 207 then determines from the setting of the configuration bits if a secret key exists, and if no secret key exists, what method is to be used to generate the secret key.

If it is determined in step 305 that a key is to be automatically generated, then the FSM 207 will proceed to step 306 in FIG. 3 and use the necessary system resources to produce the key. In step 306, the CPU 201 executes a ROM coded algorithm (stored in bootROM 204) based on techniques well known to those practiced in the art of cryptography to control RNG 209, and any other peripheral resources in the system needed to produce a satisfactory key value are utilized under the control of the FSM 207. If a key is not to be automatically generated, then the FSM 207 will proceed from step 305 to step 307 and load a key (Key1) from an external source (either debug interface 220 or communication peripheral 213, as selected by a configuration bit set in step 304). Again, the CPU 201 executing a ROM coded algorithm and any other peripheral resources necessary can be used under the control of the FSM 207 to perform the task of loading the key value from the external source. Following either state 306 or 307 where a key has been internally generated or loaded into the device, the key is stored in the NVDS memory 208 in step 308, and all traces of the key are then removed from the RAM memory 206 of the system and CPU 201 registers by setting those memories to a trivial value. This step enhances the overall security and tamper resistance of the device. Further, a configuration bit 205 will be set in step 308 to indicate that a valid secret key now exists in the device. Once a secret key exists, it will be copied from NVDS 208 (or wherever it has been stored) into a register in the cryptoblock 202 as indicated by step 309. The cryptoblock 202 is now capable of protecting information using normal cryptographic methods.

In step 310 of FIG. 3, the FSM 207 determines if any other restrictions to operation have been requested, based on configuration bits 205 that were set in step 304. These restrictions are based on the security policy to be implemented, and could include such things as not allowing the secret key value to be read by the FSM 207, to prevent the secret key value from being passed back to the CPU 201.

Some security policies might require the ability to read back a key after deployment, but other security policies might however consider this a security risk. The option bits allow these decisions to be made during the Pre-Deployment phase of the product, so a single device design can meet the needs of many different applications.

Additional actions may be taken by the pre-deployment user during the configuration phase, such as loading and encrypting the CPU program and generating or loading additional keys which are to be locked after deployment. These actions occur in step 310 of FIG. 3. Once all of these actions have been completed, the pre-deployment user will proceed to step 311, which is the final step before deployment of the device. Depending upon security policy requirements, the configuration bits 205, which until this time were re-configurable by the pre-deployment user, can be locked. Once locked, it no longer possible to change the secret key, or alter any of the pre-deployment user controllable configuration bits 205 unless the device is returned to the VIRGIN state by step 303. In addition, by setting of the configuration bits 205, no other system in the device will be able to access the key or keys other than the FSM 207. Such other systems could include but are not limited to debug ports, diagnostic logic and trace modules.

The device may also be returned to a VIRGIN state condition 303 after some period of use. Two methods are provided to return the device to the VIRGIN state, so that the system containing the device can be redeployed with different secrets and different policies for protecting those secrets. One method is by sensing whether a logical state of sensing pin 211 of MCU 215 is indicative that a re-initialization of all memories is requested, such re-initialization destroying any keys that may have been previously stored. This method also serves as a tamper proofing mechanism, since the sensing pin can be connected in such a way that a physical attempt to access the device will activate the signal, causing the secrets of the device to be rendered unreadable by destroying the keys. State 303 may be entered upon determination that sensing pin 211 is in a state requesting re-initialization of the device either at any time or only at power-up, depending on how re-initialization is enabled by option bits. A second method would be by command from the CPU 201 to the FSM 207 in state 312. This method would be used for redeployment, or possible remote disabling of a system that may have been compromised. By remote disabling, it is meant that in the event that physical control of the device or system that contains secrets or confidential data is lost such as by theft of the system or by other means, then a remote signal such as a disable command can be sent to the system by communication paths such as the Internet or by other paths that might exist to the system, to erase the keys stored in the NVDS 208 and render the secrets or confidential data of the system that may be stored variously within the MCU 215 or the security system 216 unusable. In an alternative, if a remote signal such as a confirmation signal is not received after some predetermined time interval or regularly at predesignated timing, the system will erase the keys stored in the NVDS 208 and render the secrets or confidential data of the system that may be stored variously within the MCU 215 or the security system 216 unusable. These methods of omission, including but not limited to time interval setting and method of communication, would be selected and controlled by setting option bits in step 304. Returning to step 303 from step 312 is also selectable by configuration bits 205. If it is so desired by the security officer, this path to return the device into the VIRGIN state can be enabled or disabled, meaning that it may or may not be possible for the CPU to cause erasure of the NVDS, depending on configuration bit settings.

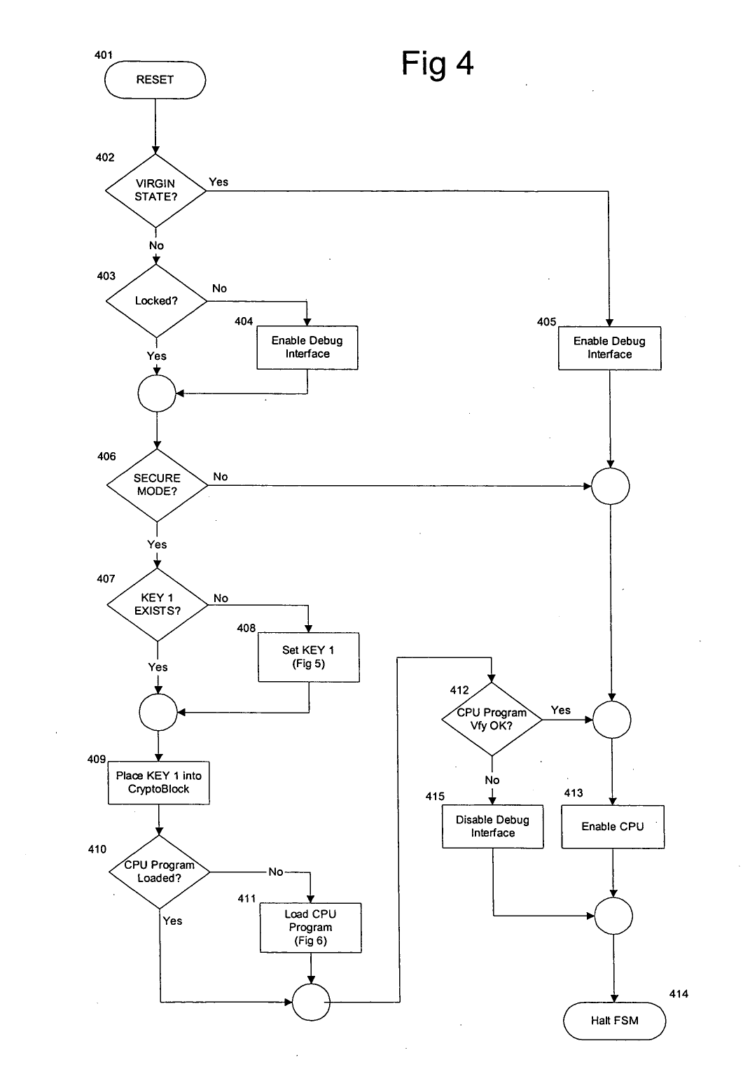

FIG. 4 shows in greater detail the basic actions to be taken by the FSM 207. The FSM 207 starts from a reset indicated by step 401 and proceeds to step 402 where the FSM 207 determines if the device is in the VIRGIN state 102. If the device is in the VIRGIN state 102, the FSM 207 proceeds to step 405 where it will enable the debug interface 220, then to step 413 where it will enable the CPU 201, and then to step 414 where operation of the FSM 207 will be halted. Until such time as a pre-deployment setting of the configuration bits occur, the security features of the product are effectively disabled via this path. This demonstrates that the MPU 215 may operate in a normal, non-secure fashion, even though security system 216 is present on the same device, and that this operation will occur by default. Such operation is a desirable feature for some applications of MCUs, where a single system design may need to operate in either secure or non-secure fashion, and having this default operation as a normal, non-secure MCU may save the cost of configuration.

If it is determined in step 402 of FIG. 4 that the device is not in the VIRGIN state 102, then additional configuration bits 205 are tested. In step 403, it is determined if the configuration bits 205 are to be locked, by testing of the configuration bit defined to indicate locking of all configuration bits 205. If the configuration bits 205 are not to be locked, the FSM 207 enables the debug interface 220 in step 404. Thereafter in step 406, testing of one of the configuration bits that has the purpose of identifying if the device is to operate in a secure mode is performed. If this bit has not been set, then the security function of security system 216 is disabled, but the function of the MCU 215 is enabled. This configuration option is provided so that the device can be locked prior to deployment, and still operate as a normal non-secure MCU. As previously explained, this feature has value in some applications. The advantage of locking the device is to prevent attempts to reverse engineer the function of the security system 216 by end users, since the debug interface 220 will also be disabled when the configuration bits are locked.

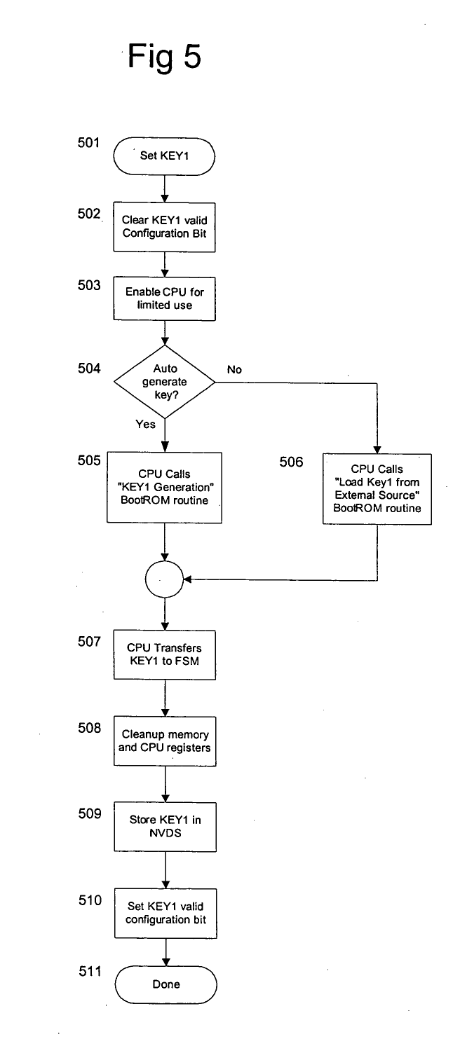

When the security system 216 operates in a normal case, the FSM 207 will progress to step 407. If the device is still in the pre-deployment phase, then a secret key (Key1) might not yet exist. If this is the case, then the FSM 207 will proceed to step 408 and generate or load the key. Not shown in step 408 is the further detail that if a key is not to be automatically generated, but is to instead be loaded from an external source, additional testing of the configuration bits can be made to determine this situation, and the FSM 207 will oversee the loading of that key rather than the generation of a key internally. This detail is presented in FIG. 5, which will be described later. In either case, once a key has been generated and stored, the FSM 207 will place a copy of the key into the cryptoblock 202 as shown in step 409.

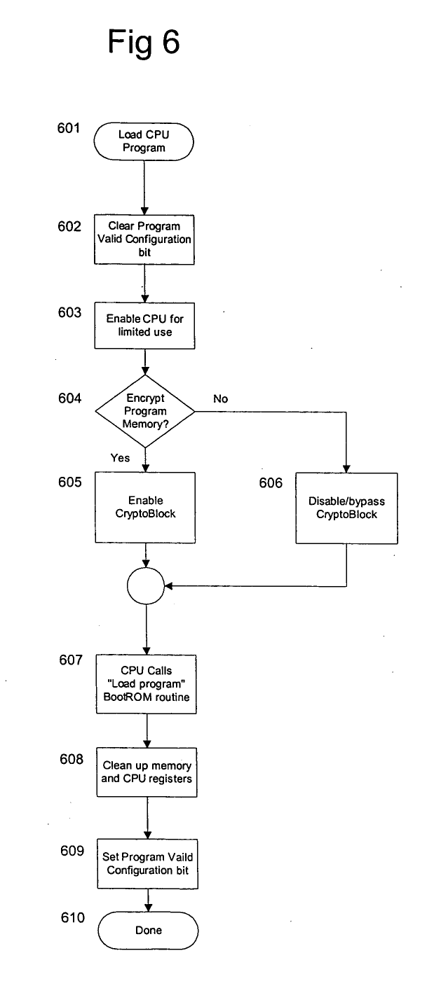

The configuration bit indicating if CPU program encryption is being used, as well as the configuration bit indicating if the CPU program has been loaded, are thereafter tested in step 410 of FIG. 4. If the program has not been loaded, then the FSM 207 proceeds to step 411 where it will load the program, using the secret key value and the resources of the MCU system 215. The details of step 411 will be described later with reference to FIG. 6. In either case, once a CPU program is loaded, the FSM 207 in step 412 will verify if the program loaded verifies correctly. The verification may utilize resources of the MCU system 215 under the control of the FSM 207 as previously described. Finally, if all the CPU program verifies correctly, the CPU 201 is enabled in step 413, and operation of the FSM 207 is thereafter halted in step 414. At this point, the MCU 215 is operating with a verified program and a secret key, the value of which is unknown by the CPU 201 and which has been loaded into the cryptoblock 202.

It should be understood that the VIRGIN state 102 is the condition of the device following manufacture and test, and before any user information or secrets have been placed on the device. Determining that the device is in a VIRGIN state may be done by several techniques. For example, although not necessarily limited thereto, determination that the device is in a VIRGIN state may be by sensing the state of memory elements that have been designed to power up into a known state and retain their state after initial power application (even if power is later removed), or by initial values placed into a portion of the NVDS 208 or configuration bits 205 at time of manufacture of the device. Regardless of how the VIRGIN state is identified, the common characteristic is that the memories will be set to a known state, and there will be no usable secret keys in the device when in this state. To avoid confusion, the term “zeroized” is used to describe the state of memory locations which have been set to a known state as part of the initialization process which places the device into the VIRGIN state. The actual content of the memory locations could be values other than zero, but are values know by the FSM 207 to represent non-valid data for those memory locations.

It should be further understood that the security system 216 provides a means by which failsafe operation can be achieved in the automatic key generation process. If for example, power was to be removed from the security system 216 during the process of generating and storing a secret key, but before the complete key value was written into NVDS 208, then the insecure condition of a non zeroized key value, with an incomplete and thus weak key would occur. It is within the ability of the security system 216 to deal with this condition, by using the configuration bits 205 as a method to signal the proper completion of selected critical tasks such as key generation. In particular, the FSM 207 sets a configuration bit before beginning key generation, and resets that bit upon successful generation of the key. If the process failed to complete, then the next time the system was reset and restarted, the FSM 207 would be able to detect the error, and take corrective action. For this case, FSM 207 would begin the generation of a replacement secret key, even though the secret key location was no longer zeroized. This method of using the configuration bits 205 for error identification and recovery can also be applied to recover from other malfunctions. In the most strict security scenarios, the configuration bits being set as a result of certain errors could cause a re-initialization of the device, returning it to a VIRGIN state 102, and thus destroying any secrets or partial secrets that it might contain. This behavior could be desired for some applications of the device, as power supply interruption is a method that an unauthorized user might use in an attempt to cause secrets of the device to be exposed.

Another aspect of the security system 216 is that at least one of the configuration bits 205 will serve the function of locking all configuration bits 205. Once this bit has been set into the locked condition, then it will be impossible for the state of any configuration bit 205 to be changed, unless the device is commanded to return to the VIRGIN state 102. Setting the lock bit would also serve other useful functions such as disabling debugging interfaces that might exist in a particular implementation of the system. It is envisioned that a device will be set to the VIRGIN state by the manufacturer, and will remained unlocked while a trusted person is configuring the system for use. Once the system is configured, the lock bit would be set before the system is exposed to any untrustworthy environment.

While the previous description makes mention of a single secret key being generated and stored automatically on reset, if such a key was not previously generated, the security system 216 provides for the generation and storage of a multiplicity of secret keys. The first key, which may be produced automatically if the configuration bits 205 are so set, is referred to as “Key1”. In the pre deployment stage this Key1 can be generated automatically or set by the security officer. Any additional keys are referred to as “User keys” and since a multiplicity of user keys can exist, they can be identified by a number suffix, such as User Key 1, User Key 2. User Key N. There is no limit imposed on the number of keys produced and stored, or the length of those keys. The memory capacity and design of the system alone would establish those limits. User keys may be generated at any time after the system has been configured, and even after the lock bit has been set.

To make use of any secret key, the FSM 207 will be called into action, either by the setting of the configuration bits (for Key1), or by request of the CPU 201 (for user keys). Referring to FIG. 4, if the configuration bit causes the key value to be accessed, then the following sequence is one method by which the security system 216 can operate. Following a RESET at step 401, the FSM 207 determines at step 402 that the device is not in the VIRGIN state 102, then determines that the configuration bits 205 indicate a key is to be used by the device at step 406, and then determines that the key value is not zeroized at step 407. This means that a key has already been generated (or placed into the system during pre-deployment by the security officer). The FSM 207 then proceeds to automatically access that key, and place it into a hardware register in cryptoblock 202 in step 409.

Possible implementations of such a cyptoblock would be an AES (Advanced Encryption Standard) engine, an RSA engine (encryption scheme proposed by Rvest, Shamir and Adleman) and many others, the operation of these cryptographic engines are well understood to those skilled in the art. Once the secret key has been loaded into such a cryptographic engine, all data that passes through the cryptographic engine will be encrypted or decrypted with the value of the secret key. The cryptographic engine datapath can be controlled by the CPU 201 or by a DMA controller 214, or by any of many techniques to cause digital data to be supplied to the cryptographic engine input. The result is that all information passing through the datapath may be encrypted by this secret key that is not accessible or known to anyone outside of the device. The information so encrypted cannot be practically decrypted without this particular device present. Other methods such as biometrics, passwords, etc., not particularly described herein, can be used to ensure that the CPU 201 does not allow the secret key to be accessed and loaded into the cryptographic engine until sufficient authentication of a requestor of the data is obtained.

The automatically generated Key1 can be read out of the device during the pre-deployment phase. The security system 216 will permit locking the key value, to prevent it from being passed to the CPU 201. That is, the FSM 207 will not provide key values to the CPU 201 interface without appropriate configuration bit settings during the pre-deployment phase. If the CPU 201 has not been granted key value access as part of the security policy set in the device during pre-deployment, a post deployment application cannot access the key values, enhancing the security of the system. For systems where it is desired to have access to the key values by post deployment application software, the option bit settings will permit this less secure mode of operation.

In the CPU method of access for user keys, the CPU 201 will communicate to the FSM 207 the request to load a key into the cryptographic engine (cryptoblock 202). In implementations where a multiplicity of keys may exist, the CPU 201 will request the key by number, where the number relates to the storage location of the key, not the value of the key. Actual access of the key is handled by the FSM 207. In this fashion, under the most strict security policy, the CPU 201 is not aware of the actual key value, and as a result cannot be caused to disclose the key value outside of the MCU 215, even if some modification to the CPU program was made in an attempt to gain access to the secret information. As previously stated, in situations where the security policy desires and permits CPU 201 access to the keys, the configuration bits 205 would have been appropriately set during pre-deployment, and this higher level of security would not be present.

In the previous description, for the sake of simplicity, the keys stored in the NVDS 208 are not encrypted. To achieve a higher level of security from those most skilled in the art who would attempt to discover by physical or electrical means the content of the NVDS 208, that is the content of the user keys, the security system 216 can operate in a manner where the contents of the NVDS 208 are encrypted. In this embodiment, the “Key1” secret key and the “configuration bits” are stored in a non-encrypted section of NVDS 208. In the alternative, the “Key1” secret key and the “configuration bits” may be stored in NVDS elements that are physically separated from the NVDS 208, and implemented in a fashion to conceal their purpose and function. That is, the secret key and/or a certain number of configuration bits may be stored in a manner scattered around the device. The secret key and the configuration bits may be separated into individual bits which are spatially separated and stored on the die itself, such as in fusible links, charge storage capacitors and transistor flip-flops formed in the device substrate. Such scattered storage of the keys and configuration bits would render it very difficult for an unauthorized person to locate and determine the content of the keys. In this case, the logical function of providing the necessary capacity of non-volatile storage for Key1 and the configuration bits in a method and place accessible by the FSM 207 is necessary for proper operation of the security system 216. As a further alternative, the encryption keys and configuration bits can be stored in a battery back-up system, so that when system power is disabled, the encryption keys and configuration bits are lost.

The operation of the system with the encrypted NVDS 208 would be exactly the same for the configuration bit and Key1 generation and storage as previously discussed. However, the FSM 207, upon determining from the configuration bit 205 settings that encryption of the NVDS 208 has been specified, would proceed to automatically load the Key1 value into a special register (not shown) in the cryptographic engine or cryptoblock 202. This register would duplicate the functionality of the normal key to be used in cryptographic encryption or decryption, and a method of selection for the special register or the normal register would be provided in the design of the cryptographic block. The result of this would be a single cryptographic engine that could easily and quickly switch between two different encryption key values. The Key1 value would always be present, and when the FSM 207 needed to access the encrypted NVDS area, for storage or retrieval of information, the Key1 register in the cryptographic block would be selected, and the logical path for data flow into or out of the NVDS 208 would be via the cryptographic engine. In this way any data stored into or read from the NVDS 208 would be suitably encrypted or decrypted with the Key1 key, and the content of the NVDS 208 would only be encrypted information.

With additional logic and control for the FSM 207, it is possible to provide security system 216 as having some areas of the NVDS 208 that are encrypted and others that are not. Once a value has been accessed from NVDS 208, the most probable use of that value will be as a cryptographic key (user key), so the FSM 207 will place that value into the regular key register of the cryptographic engine or cryptoblock 202. When a transfer of data occurs under CPU 201 control (or DMA 214 control or any other method of transfer that the system has implemented), and that transfer has been identified to need encryption, then the control logic in the cryptographic engine will select the user key register, and the data will be automatically encrypted or decrypted as required with the specified user key, not the secret Key1 value. Note that only accesses by FSM 207 can cause the Key1 register to be accessed in the cryptographic block. All CPU 201 access to cryptoblock 202 will result in using the user key register value. By providing a method that minimizes the amount of data that a user can view which has been encrypted by the secret Key1 value, the overall security of the system is enhanced. Again, by use of option bits, the security policy can be set to take advantage of this feature or not, depending upon the needs and desires of the equipment manufacturer.

Furthermore, when using a Key1 encrypted NVDS scenario, if the configuration bits are so set, then CPU 201 access to the encrypted NVDS and hence the encrypted User Keys is possible. This may be useful for some situations where the encrypted User Key needs to be read from the device by a security officer and decrypted using Key1 in order to recover encrypted storage 203 data or encrypted data stored off chip via the external storage bus 218.

To afford a higher level of security to information stored in the CPU 201 program memory, such as in RAM 206, storage 203 or external storage via the external storage bus 218, the security system 216 can be used in a similar fashion to encrypt the data contained in the CPU program memory as was done for the NVDS 208 contents. In this case it may be desirable to have a second cryptographic block that is inserted between the CPU 201 and the program memory. However, it is possible to use the same cryptographic block that is used for the data path and NVDS 208 encryption, as long as the cryptographic block has sufficient throughput and the ability to rapidly switch between two different encryption tasks. It is important for most systems that the CPU 201 not be delayed in obtaining the next instruction from program memory, so careful consideration must be given to the implementation of the cryptographic block in the instruction/data path, as would be understood by one of ordinary skill. In operation, the FSM 207, by determination of the setting of configuration bits 205, will load the instruction/data path cryptographic engine with the Key1 value and enable operation of the cryptographic engines prior to enabling the CPU 201. In this fashion, the CPU 201 will only see un-encrypted instructions/data from the instruction/data memory, via the cryptographic engine. For this encryption/decryption of the information in the CPU instruction memory, the Key1 value will always be used.

When using the encrypted program memory mode of operation, an issue of consideration is the manner in which the program is initially encrypted and placed into program memory, particularly when Key1 is automatically generated by security system 216 and therefore only known to security system 216. Two methods are provided to deal with encrypting and loading the program memory. In a first method, a key known only by the security system 216 is used, and in a second method a key is provided to the security system 216. The method to be used is determined by setting of an appropriate configuration bit.

In the first method noted above, the Key1 value is unknown outside of the security system 216. It is presumed that a Key1 value has already been produced and loaded into the NVDS 208 and cryptoblock 202. Following a reset, the FSM 207 will proceed thorough steps 401 through 409 in FIG. 4, and then in step 410 will determine that the CPU program memory has not yet been loaded, causing the FSM 207 to perform a boot-loader function in step 411. The boot-loader function can be performed with the assistance of the CPU 201 so long as the process is under the absolute control of the FSM 207 and the CPU 201 is executing program code from a secure source such as bootROM 204.

The boot-loader function of step 411 in FIG. 4 is now described in greater detail with reference to FIG. 6, whereby the load CPU program is entered in step 601. In step 602, a “Program Valid” configuration bit is cleared by FSM 207, and CPU 201 is subsequently enabled for limited use in step 603. In step 604, it is determined whether program memory will be encrypted. This determination can be made by FSM 207, by checking option bits. Upon determination in step 604 that the content of program memory is to be encrypted, cryptoblock 202 is subsequently enabled in step 605 so as to encrypt the received program information. Upon determination in step 604 that the content of program memory is not to be encrypted, cryptoblock 202 is disabled in step 606 and encryption of the received program information is thus bypassed.

The boot-loader function thereafter will cause external communication peripheral 213 of the device to be activated, to receive the program information in a non-encrypted form as indicated in step 607 of FIG. 6. Possible communication peripherals would include but are not limited to UARTs, synchronous serial interfaces, USB, Ethernet, parallel port, and other commonly used MCU interfaces. The FSM 207, or the CPU 201 or DMA 214 under the control of the FSM 207, will cause data input to the communication peripheral to be passed through the cryptographic engine or cryptoblock 202 that would normally have been available to be in the CPU 201 instruction path, and this program information will be encrypted. FSM 207 will then cause the encrypted program information to be stored into the program memory in an encrypted form. During this boot-loading operation, the CPU 201 if used executes un-encrypted program code from the bootROM 204, so that there is no conflict with use of the cryptographic engine in the program instruction path, which would be concurrently used to encrypt the control program which is being loaded.

As noted above, the “Program Valid” Configuration bit is used to indicate successful encryption of the program code. This bit is cleared at step 602 of FIG. 6, and is subsequently set at step 609 when encryption has been successfully completed. As indicted in step 608, all CPU registers and memory space used during the encryption process are cleaned prior to the valid configuration bit being set. If the program code is not to be encrypted, then the same operations occur as previously described, except that in step 606 the cryptoblock 202 is disabled or bypassed, so that data from the communication peripheral is passed without encryption into the program memory. The boot-loader function is then ended in step 610.

The method of storing the encrypted program described previously is very secure because the secret Key1 is not known outside of the security system 216. However, this method does not satisfy requirements of some users to be able to construct secure systems using pre-loaded program memory devices. Such pre-loaded devices might be desired because of reduced system manufacturing cost, or better performance characteristics. Therefore a second method to encrypt and load the program into memory is provided. In this method, the program is encrypted by external means, and the key that was used to encrypt the program is provided to the security system 216 by a trusted person as part of the configuration process. This second method of encrypting and loading program information is described in the following with reference to FIG. 5.

In FIG. 5, the Set KEY1 flowchart is entered at step 501. In step 502, a “KEY1 Valid” configuration bit is cleared by FSM 207, and CPU 201 is subsequently enabled for limited use in step 503. In step 504, it is determined whether Key1 will be auto-generated by RNG 209 and cryptoblock 202 of security system 216, and CPU 201, under the control of bootROM 204. This determination can be made by FSM 207, by checking configuration bits. Upon determination in step 504 that RNG 209 will auto-generate Key1, CPU 201 calls up the “Key1 generation” routine from bootROM 204 to control generation of Key1 by RNG 209. Upon determination in step 504 the Key1 will not be autogenerated, CPU 201 calls up the “load Key1 from external source” routine from bootROM 204 to control download of Key1 from the external source. Thus, steps 505 and 506 indicate the alteration of FSM 207 activity if the configuration bits have indicated that a Key1 value is to be provided externally. To add another layer of security, configuration bits may be set so that after auto-generation, the content of the encryption key can be maintained secure and access to the auto-generated encryption key by an authorized user or system technician may be prevented during the pre-deployment stage.

In step 507 of FIG. 5, CPU 201 subsequently transfers Key1 to FSM 207, whereby Key1 is subsequently stored in NVDS 208 by FSM 207 in step 509. As indicated in step 508, all CPU registers and memory space used during the encryption process are cleared prior to storage of Key1 in NVDS 208. Thereafter, the “Key1 Valid” configuration bit is set in step 510, and the set Key1 function is ended in step 511.

In another aspect, FSM 207 can be used to further safeguard the CPU program from tampering. One of the tasks beyond that of generating and handling keys can be for the FSM 207, if so instructed by the configuration bits 205, to automatically verify that the control program for the CPU 201 has not been altered before transferring control to the CPU 201. Verification that the control program for CPU 201 has not been altered or tampered with can be done by any one of many methods well known to those practiced in the art of cryptography, and error detection and correction. For example, a checksum or CRC value can be computed, or a more sophisticated HASH digest verified, or some combination of HASH and secret Key1 can be used such as HMAC (using SHA-1 or SHA-2 or other suitable HASH method in conjunction with the secret key). In accordance with this aspect, FSM 207 performs testing of the CPU control program memory content using any of the above noted methods, prior to allowing the CPU 201 to begin operation. If FSM 207 determines that the program memory is no longer valid, then responsive to the configuration bits 205, FSM 207 takes actions to prevent compromise of the secret data protected by the keys stored in the security system 216. Possible actions by FSM 207 would be to enter a non-functional locked or trapped state, which can not be exited until some additional action or sequence of I/O signals occurred. This is indicated in steps 412 and 415 of FIG. 4. This sequence could be determined by patterns of configuration bits 205, known only to those who programmed the configuration bits 205 in the first place. Alternatively, the FSM 207 could be caused to re-initialize the entire device, returning it to the VIRGIN state, and in the process discarding all the stored keys, thus protecting the encrypted data from compromise. These are just two of many possible methods by which a tampered with system can be caused to further protect stored secrets to a higher level than currently available systems.

It should be understood that the invention should not necessarily be limited only to the embodiments as described. For instance, although the security system 216 as shown in FIG. 2 includes finite state machine (FSM) 207 that provides management and control of the encryption key and confidential data, in the alternative a second general computer processing unit (CPU) can be configured to perform the tasks of the FSM 207 as described above. In such a dual processor implementation, security would be strictly controlled and managed by the second processor, which may be designed to have increased tamper resistance. In this alternative, the level of security would not be as great as the case in which a finite state machine is used to provide management and control, but the security of such a dual processor security system may be further improved by sealing the device in a tamper resistant encapsulant or package.

The invention being thus described, it should be apparent that the same may be varied in many ways. Such variations are not to be regarded as a departure from the spirit and scope of the invention, and all such modifications as would be obvious to one of ordinary skill in the art are intended to be included within the scope of the following claims.

What is claimed is:

1. A device comprising:
a microcontroller block including a general purpose computer processing unit that controls operation of the device; and
a security system coupled to the microcontroller block, the security system including a finite state machine that uses an encryption key to control encryption and decryption of confidential data used by the computer processing unit, and that maintains content of the encryption key and prevents access to the encryption key by the computer processing unit and an end user of the device.

2. The device of claim 1, wherein the security system further comprises:
a non-volatile memory that stores the encryption key and configuration bits for the device, the finite state machine controls loading of the encryption key into the non-volatile memory prior to deployment of the device to the end user; and
a cryptographic engine that encrypts and decrypts the confidential data using the encryption key stored in the non-volatile memory under control of the finite state machine.

3. The device of claim 2, wherein the microcontroller block further comprises a debug interface that provides the configuration bits from an external source for loading into the non-volatile memory of the security system.

4. The device of claim 2, wherein the finite state machine locks a state of the configuration bits stored in the non-volatile memory before deployment of the device to the end user.

5. The device of claim 2, wherein the finite state machine
controls generation of the encryption key responsive to a request by an authorized user prior to deployment of the device to the end user, and
maintains the content of the encryption key in the non-volatile memory and prevents access to the encryption key by the authorized user.

6. The device of claim 2, wherein the microcontroller block further comprises program memory for storing programming for the computer processing unit,
the cryptographic engine encrypting content of the program memory prior to deployment of the device to the end user.

7. The device of claim 2, wherein the finite state machine determines validity of the encryption key stored in the non-volatile memory, and upon determination that the encryption key is invalid, reinitializes the security system and the microcontroller block, and erases the encryption key.

8. The device of claim 2, wherein the microcontroller block further comprises program memory for storing programming for the computer processing unit,
wherein the finite state machine determines whether the programming stored in the program memory has been tampered with, and upon detection of tampering enters a locked state.

9. The device of claim 2, wherein the microcontroller block further comprises program memory for storing programming for the computer processing unit,
wherein the finite state machine determines whether the programming stored in the program memory has been tampered with, and upon detection of tampering reinitializes the security system and the microcontroller block, and erases the encryption key.

10. The device of claim 2, wherein the microcontroller block further comprises a communications peripheral, the finite state machine erases the encryption key stored in the non-volatile memory responsive to a remote disable command received by the communications peripheral, to render the confidential data unreadable.

11. The device of claim 2, wherein the microcontroller block further comprises a communications peripheral, the finite state machine erases the encryption key stored in the non-volatile memory if a remote confirmation signal is not received by the communications peripheral at a predesignated timing, to render the confidential data unreadable.

12. The device of claim 1, wherein the security system further comprises a random number generator and cryptographic block that can be utilized to generate the encryption key.

13. The device of claim 1, wherein the microcontroller block further comprises a communications peripheral, the computer processing unit downloads the encryption key from an external source via the communications peripheral and transfers the encryption key to the non-volatile memory for loading, and clears registers and memory within the microcontroller block that temporarily store the encryption key prior to deployment of the device to the end user.

14. A device comprising:
a microcontroller block including a general purpose computer processing unit that controls operation of the device; and
a security system coupled to the microcontroller block, the security system comprising
a cryptographic engine that uses an encryption key to encrypt and decrypt confidential data used by the computer processing unit,
a random number generator and cryptographic block utilized in generation of the encryption key,
a non-volatile memory that stores the encryption key and configuration bits that set operational parameters of the device, and
a finite state machine that controls access of the non-volatile memory so that the encryption key is used and maintained without access by the computer processing unit and an end user of the device.

15. The device of claim 14, wherein the microcontroller block further comprises a debug interface that provides the configuration bits from an external source for loading into the non-volatile memory of the security system.

16. The device of claim 14, wherein the finite state machine locks a state of the configuration bits stored in the non-volatile memory before deployment of the device to the end user.

17. The device of claim 14, wherein the finite state machine controls generation of the encryption key by the random number generator and cryptographic block, responsive to a request by an authorized user prior to deployment of the device to the end user, and
maintains the content of the encryption key in the non-volatile memory and prevents access to the encryption key by the authorized user.

18. The device of claim 14, wherein the microcontroller block further comprises program memory for storing programming for the computer processing unit,
the cryptographic engine encrypting content of the program memory prior to deployment of the device to the end user.

19. The device of claim 14, wherein the finite state machine determines validity of the encryption key stored in the non-volatile memory, and upon determination that the encryption key is invalid, reinitializes the security system and the microcontroller block, and erases the encryption key.

20. The device of claim 14, wherein the microcontroller block further comprises program memory for storing programming for the computer processing unit,
wherein the finite state machine determines whether the programming stored in the program memory has been tampered with, and upon detection of tampering enters a locked state.

21. The device of claim 14, wherein the microcontroller block further comprises program memory for storing programming for the computer processing unit,
wherein the finite state machine determines whether the programming stored in the program memory has been tampered with, and upon detection of tampering reinitializes the security system and the microcontroller block, and erases the encryption key.

22. The device of claim 14, wherein the microcontroller block further comprises a communications peripheral, the finite state machine erases the encryption key stored in the non-volatile memory responsive to a remote disable command received by the communications peripheral, to render the confidential data unreadable.

23. The device of claim 14, wherein the microcontroller block further comprises a communications peripheral, the finite state machine erases the encryption key stored in the non-volatile memory if a remote confirmation signal is not received by the communications peripheral at a predesignated timing, to render the confidential data unreadable.

24. The device of claim 14, wherein the microcontroller block further comprises a communications peripheral, the computer processing unit downloads the encryption key from an external source via the communications peripheral and transfers the encryption key to the non-volatile memory for loading, and clears registers and memory within the microcontroller block that temporarily store the encryption key prior to deployment of the device to the end user.
